(19) United States
(12) Patent Application Publication
(10) Pub. No.: US 2014/0280096 A1
(43) Pub. Date: Sep. 18, 2014

(54) Multi-dimensional Matching System and Method

(71) Applicant: Joao Gonzaga, Chicago, IL (US)

(72) Inventor: Joao Gonzaga, Chicago, IL (US)

(21) Appl. No.: 14/207,330

(22) Filed: Mar. 12, 2014

Related U.S. Application Data
(60) Provisional application No. 61/793,664, filed on Mar. 15, 2013.

(51) Int. Cl. G06F 17/30

(52) U.S. Cl. CPC G06F 17/3053
USPC 707/723; 707/758

(57) ABSTRACT

The functions and operations of a matching system and method are disclosed. The component features may include a multi-dimensional matching procedure utilizing both linear and non-linear weighting carried out by a positive feedback loop. Practical uses include social networking and social discovery, as well as automatic searching of people, places, deals, and other items which the system and method determine could be of interest to users, based upon user interests, preferences, and other attributes and characteristics.

This application claims priority from Provisional Application No. 61/793,664, filed on Mar. 15, 2013.

### STATEMENT REGARDING FEDERALLY SPONSORED RESEARCH

Not applicable.

### SEQUENCE LISTING OR PROGRAM

Not applicable.

### BACKGROUND

Social networking applications, as well as matching services, that are currently in use can provide many benefits and conveniences to their end users.

However, there are some apparent limitations of existing applications and services. For example, existing services will often use matching procedures which are simplistic, non-nuanced, and which bury the user with results that are only loosely related to the user's true interests.

Other services might also attempt to work around a user's stated preferences and interests. These services sometimes do so by attempting to track user actions and/or behavior, and then attempting to divine a user's “preferences” from such behavior, even if these newly-found “preferences” are different from the user's stated preferences. These services also sometimes implement such a work-around by scanning a database for other users believed to be similar to the current user, and then assuming that the current user's preferences will mirror the preferences of other users (rather than the preferences obtained from the user directly).

Also, many existing services comprise inefficient procedures for determining matches between information entries such as users, interests, objects, places, establishments, etc.

Many existing services inform the user of only some of the information associated with a matched item. This limits the user's ability to easily determine the item's additional characteristics, and to explore new attributes about the item which the user may discover to be of interest to him/her.

Additionally, such applications or services will often require affirmative steps by the end user to actively search for whatever it is that the user might be pursuing.

Finally, many of these services do not allow users the option of controlling the degree to which they are anonymous to other users as they use such services.

The present invention addresses and solves these concerns. The invention is directed toward a system and method for taking attributes and characteristics of a wide range of informational entries, and matching these attributes with users' interests. The invention avoids an avalanche of irrelevant results by using an advanced matching procedure based upon weighting and relevancy by means of a points system, in which different degrees of importance are assigned in a calculated and targeted manner to various categories of matches. Additionally, the invention uses preferences obtained directly from users, resulting in matches that are more meaningful and more valuable. Furthermore, the invention is also capable of processing efficiencies such as pre-processing, or such as integration of existing techniques such as “map-reduce” steps into its matching procedures. Additionally, the invention shares with users all the informational attributes and characteristics associated with each matched item, thereby enhancing the ability of users to explore and to discover new interests. The invention eliminates the burden on the user to search actively for items that might match the user's interest. In addition, the invention also allows users to reveal only certain information at one stage of the process of connecting with another user, and to reveal more at a later stage if the user so chooses—this allows users to maintain a degree of anonymity which many other social networking services do not permit.

### SUMMARY

In this application, the term “item” refers to an informational term and/or informational entry in a data-storage repository which is associated, in said repository, with other informational terms and/or informational entries which in turn represent the item's attributes and/or characteristics.

In this application, the term “position” refers to a geographic location or area that can be determined with some specificity. The means of determining such a position or positions might comprise cellular towers, Global Positioning System (GPS), or other techniques.

Embodiments of the presently claimed and disclosed invention are directed toward a system for, and method of, processing information collected from a data-storage repository through a positive feedback loop and/or matching procedure. Such a method would be accomplished by: collecting information from a previously existing database or other data-storage repository; operating a multi-dimensional positive feedback loop wherein a specialized, context-sensitive matching procedure is used to match portions of said collected information with other portions of said collected information; calculating the degree to which said matched information is matched to other information within the feedback loop's matching procedure; and returning and distributing calculated, context-sensitive results which are determined by the aforesaid degree to which said matched information is matched to other information within the feedback loop's matching procedure. Such a system would comprise: a database or other data-storage repository which contains information, and which contains associations and/or connections between said information and related information; and a multi-dimensional positive feedback loop wherein information collected is matched with other information collected according to a specialized, context-sensitive matching procedure.

The preferred embodiment of the invention will create such results using such collected information as items, informational terms and/or informational entries, or the likes as input data. Such items, informational terms and/or informational entries could comprise: common interests or tastes, personal characteristics, features or characteristics of places or locations, attributes of deals, discounts, or sale specials, attributes or characteristics of one or more users; attributes or characteristics of one or more users; attributes of a user combined with attributes of a place, location, business enterprise, or other establishment; or attributes of a user combined with such informational constructs as deals, discounts or sale specials, and/or supplemental user-entered information such as a review or recommendation that will become associated with existing informational entries, and/or the likes thereof. The preferred embodiment will also return such results to a user in visual form.

In some embodiments, the system or method will include a position-tracking function, and will use the output of this position-tracking function in subsequent operations. Such a function might be invoked in response to certain user actions.

In some embodiments, said positive feedback loop and/or matching procedure will be multi-dimensional, and as such it will determine how highly to rank, or how heavily to weight, or what value to assign to, or what number of points to assign to, a certain overall matching result by taking into account a number of separate matches between attributes, characteristics, items, informational terms and/or informational entries.

In some embodiments, the list of attributes, characteristics, items, informational terms and/or informational entries in the data-storage repository will include interests and/or preferences of each associated user; personal characteristics, features or characteristics of places or locations; attributes of particularized deals or discounts, and/or user-created recommendations. Such characteristics or features of a user might include: age; geographical position; tastes in food or cuisine; interests in movies, stage shows or literature; interests in music; hobbies; romantic interests; etc. Such characteristics or features of a place or location might include available menu items, items available for purchase or rent, business hours, and/or category of establishment or category of business with which the location is associated.

In some embodiments, said ranking or weighting of results will be based on a point system, wherein each separate match creates a certain number of points and the overall result is a function of the points resulting from all of the separate matches.

In some embodiments, the positive feedback loop will comprise a linear matching procedure. Such a linear procedure would calculate a value and/or number as measured in points, or another weighting intermediary, by beginning at a predetermined number of points and decreasing the points awarded in a linear manner based upon a predetermined gap in points, or other dissimilarities, between the two inputted attributes, with a zero-point minimum. One example could be the use of this linear mechanism to determine how many points are assigned to a match if a user's age is matched with another user's age.

In some embodiments, a result or results obtained from the specialized, context-sensitive matching procedure are returned in an order determined by a function both of geographical distance of said result or results from a user, and of the number of points resulting from a match.

In some embodiments, said specialized, context-sensitive matching procedure comprises a map-reduce procedure. Said map-reduce procedure will comprise mapping steps and reducing steps. Said map-reduce procedure will split the input data into clusters, process these clusters separately using said specialized, context-sensitive matching procedure, and then aggregate the results.

In some embodiments, the system and/or method will comprise a series of “pre-processing” steps implemented by the system and/or method. In such “pre-processing” steps, initial stages of processing will eliminate results based on certain criteria. These criteria might include: whether or not an item's geographical distance from a designated user is too great; whether or not an item is within a predetermined radius of a designated user; whether or not information associated with an item indicates that a visibility preference is set to hide the entity's visibility to other users; or, whether or not information associated with an item indicates that the item has active status, and/or lacks the status of being inactive, deleted, and/or disabled. This “pre-processing” procedure will conduct binary filtering based on these criteria, and will return a predetermined number of item results, which then will be processed, matched, and ranked using subsequent data-collecting and/or data-processing procedures.

In some embodiments, portions of the information in said data-storage repository will be associated with multiple hierarchical layers or tiers of broader upper categories and narrower sub-categories. In such embodiments, the broader and narrower categories in an associated pair could be designated, respectively, as a “parent” category or an equivalent term and a “child” category or an equivalent term. In such embodiments, the broader and narrower categories can be associated with attributes, items, or characteristics following a hierarchical model by creating a parent/child relationship between attributes, items, or characteristics with the upper and narrower categories. In some of these embodiments, the matching procedure implemented by or within the positive feedback loop could assign more weight to matched informational items within the same narrower “child” category than it assigns to matched informational items within the same broader “parent” category.

In some embodiments, a user who identifies an item that said user wishes to mark for future reference can designate such an item as a “favorite”, or equivalent term, thereby creating an informational entry containing information associated with said item, and/or an identifier that can be used to find such item. In some cases, said item might be another user.

In some embodiments, a user can request a specialized connection with another user—if said request is accepted, this connection will be designated as a “buddy” relationship, or equivalent term.

In some embodiments, items, informational terms and/or informational entries can be designated to be given an increased value and/or an increased number of points when matched by said specialized, context-sensitive matching procedure. In some embodiments, the weighting of an item or items processed by the positive feedback loop and/or matching procedure could be changed in response to user directives. In some of these embodiments, a user could designate an informational entry such as an item, attribute, and/or characteristic as belonging to a specific category, which would cause the system and/or method to adjust the weight that is calculated when said designated informational entry is matched. By way of example, a user's designation of an informational entry as the above-mentioned designations of “favorite” or “buddy” would cause the positive feedback loop and/or matching procedure to upwardly adjust the weight when said informational entry is matched.

In some embodiments, items, informational terms and/or informational entries can be designated to be given a significantly increased value and/or a significantly increased number of points when matched by said specialized, context-sensitive matching procedure. In some embodiments, users can designate an informational entry such as an item, attribute, or characteristic to be in a category called “mood mode”, or an equivalent term. In such a case, the positive feedback loop and/or matching procedure would significantly increase the weight that is calculated when said informational entry is matched. In some of these embodiments, the “mood mode” designation would be binary, and a user could toggle or switch it at will from on to off and back again.

In some embodiments, items, informational terms and/or informational entries which are deemed to be equivalent to each other are capable of being associated with information which identifies them as being equivalent to each other, and are capable of being processed identically by said specialized, context-sensitive matching procedure. In some of these embodiments, the system and/or method will assign an internal system identifier to every informational term which a user picks to identify said user's preferred information entry correlating to that user's particular attribute or characteristic. In such embodiments, the system and method would be capable of assigning the same internal system identifier to informational terms deemed equivalent to each other, such as those informational terms which designate items, attributes, characteristics, or categories. An example of this might be when the same internal system identifier is assigned to the terms “seltzer” and “soda water”. In cases where multiple items have the same internal system identifier, the system and/or method will process them identically. In some embodiments, items, informational terms and/or informational entries deemed to be related to each other are capable of being associated with information which identifies them as being related to each other, and are capable of being processed in analogous ways by said specialized, context-sensitive matching procedure. In some of these embodiments, information associated with specific items or other informational terms will designate them as being related to each other, even if they do not have the same internal system identifier. An example of this might be the term “earring” being related to the terms “piercing” or “pierced”. The system and/or method will be capable of processing such related items in analogous ways.

In some embodiments, items, informational terms and/or informational entries are capable of being added to a profile, and wherein an opportunity is provided to associate additional information with said items, informational terms and/or informational entries. In some of these embodiments, each user who adds a term, attribute, and/or characteristic to a profile will have the opportunity to associate additional information with said term, attribute, or characteristic. This additional information might take the form of a review, personal note, or photo. This additional information might also take the form of a more detailed and/or specific description. In some of these embodiments, a business or other establishment could add additional information to a generic term, attribute, or characteristic.

In some embodiments, an item or other informational entry might be associated with, and/or capable of being associated with, aggregate data collected from multiple users or multiple items. By way of example, an item representing a place, location or establishment might be associated with aggregate data which represents characteristics or attributes of users who are at, and/or have previously been at, said place, location or establishment. In some of these embodiments, the prior and/or current positions of a user or users would be determined through the position-tracking function, recorded, and associated with said users' profiles. In some of these embodiments, the position-tracking function of the system and/or method would provide a user's position, after which said item, and its associated aggregate data, could also be associated with or matched with said user's position. In some of these embodiments, said aggregate data will be compiled into percentages or numbers of users with similar characteristics who are at, and/or who have been at, said location. In some of these embodiments, said aggregate data could be associated with certain time periods, including but not limited to times of the day, the week, the month, or the year, In some embodiments, said percentages, numbers, and/or associations would be represented to a user or users through such visual representations as bar diagrams, pie charts, specific colors, alphanumeric characters, tree diagrams, Venn diagrams, etc. In some of these embodiments, said aggregate data, matches, and/or associations could be represented and/or returned to a user or users in a visual representation or other user-decipherable form, such as a visual map with highlighted areas, designated as a “heat map” or equivalent term.

In some embodiments, a degree of user anonymity is maintained because predetermined information (and/or categories of information) which may be capable of specifically identifying a user or users is not disclosed to other users. However, in some of these embodiments, previously undisclosed user information can be shared in response to user instructions, queries, or other affirmative steps. In some of these embodiments, said undisclosed user information will comprise all of said user's attributes, characteristics, and other associated information which makes up a user's full profile. In some of these embodiments, the affirmative steps in question will comprise the affirmative steps needed for the system and/or method to establish a “buddy” specialized connection relationship between two users.

In some embodiments, an alert or other communication can be sent and/or is capable of being sent to a user and/or receiving point when or after said specialized, context-sensitive matching procedure determines a match and/or returns a matching item, informational term and/or informational entry whose value and/or another weighting intermediary and/or whose number of points surpasses a predetermined threshold; whose distance from said user and/or receiving point is within a certain radius; and/or whose designation matches a certain predetermined status, such as said “buddy” status, or said “favorite” status, or equivalent terminology.

### BRIEF DESCRIPTION OF THE DRAWINGS

FIG. 1 shows an illustration of the relationship between broader “parent” categories and narrower “child” sub-categories.

FIG. 2 shows a basic representative embodiment of a positive feedback loop used by the system and method.

FIG. 3 shows a representative embodiment of a positive feedback loop used by the system and method, comprising the translation of results into a visual format comprising an item list and sub-lists.

FIG. 4 shows a representative embodiment of a positive feedback loop used by the system and method, comprising the opportunity for a specified user to change his or her profile, add interests, and/or deleted interests.

FIG. 5 shows a representative embodiment of a positive feedback loop used by the system and method, comprising the translation of results into a visual format comprising an item list and sub-lists, and also comprising the opportunity for a specified user to change his or her profile, add interests, and/or deleted interests.

FIG. 6 shows a representative embodiment of a positive feedback loop used by the system and method, comprising a matching procedure placed within the overall data processing procedure.

FIG. 7 shows a representative embodiment of a positive feedback loop used by the system and method, comprising the outputting of results from the pre-processing procedure and the culling of attribute and/or characteristic data which is then used in a matching procedure.

FIG. 8 shows a representative embodiment of a positive feedback loop used by the system and method, comprising the outputting of results from the pre-processing procedure and the culling of attribute and/or characteristic data which is then used in a matching, mapping and reducing procedure.

FIG. 9 shows a representative embodiment of a positive feedback loop used by the system and method, comprising the outputting of results from the pre-processing procedure into a matching procedure, after which said results are divided into clusters, submitted to separate matching tasks, and then processed by a reducing procedure.

FIG. 10 shows a representative embodiment of a positive feedback loop used by the system and method, comprising the outputting of results from the pre-processing procedure and the culling of attribute and/or characteristic data which is then used in a matching procedure, after which said results are divided into clusters, submitted to separate matching tasks, and then processed by a reducing procedure, and also comprising the translation of results into a visual format comprising an item list and sub-lists, and also comprising the opportunity for a specified user to change his or her profile, add interests, and/or deleted interests.

FIG. 11 shows a representative embodiment of the system and/or method's capability to aggregate, associate, and display data in a “heat map” format.

FIG. 12 shows a representative embodiment of the system and/or method's capability to establish a “buddy” relationship, which affects the degree to which users' information is shared with other users.

FIG. 13 shows a representative embodiment of the system and/or method's interface on a mobile device.

FIG. 14 shows a representative embodiment of the system and/or method's interface component representing a People/Matches Overview on a mobile device.

FIG. 15 shows a representative embodiment of the system and/or method's interface component representing Match Details on a mobile device.

FIG. 16 shows a representative embodiment of the system and/or method's interface component representing “Match Details, Expanded” on a mobile device.

FIG. 17 shows a representative embodiment of the system and/or method's interface component representing a buddy request function on a mobile device.

FIG. 18 shows a representative embodiment of the system and/or method's interface component representing a invisibility function on a mobile device.

FIG. 19 shows a representative embodiment of the system and/or method's interface component representing a Related Interests function on a mobile device.

FIG. 20 shows a representative embodiment of the system and/or method's interface component representing an interest-based related supplemental information function on a mobile device.

FIG. 21 shows a representative embodiment of the system and/or method's interface component representing a place and/or interest-based related supplemental information function on a mobile device.

FIG. 22 shows a representative embodiment of the system and/or method's interface components representing Place Recommendations and/or Place Match Details on a mobile device.

FIG. 23 shows a representative embodiment of the system and/or method's interface components representing Place More Info and Place Offers functions on a mobile device.

FIG. 24 shows a representative embodiment of the system and/or method's interface components representing a Mood Mode function on a mobile device.

FIG. 25 shows a representative embodiment of the system and/or method's interface components representing Deals/Matches Overview and Deal Details functions on a mobile device.

FIG. 26 shows a representative embodiment of the system and/or method's interface components representing a messaging function on a mobile device.

### DETAILED DESCRIPTION OF THE INVENTION

The following detailed description of the invention refers to the accompanying figures. This detailed description does not limit the invention, nor do the accompanying figures. Instead, they merely serve to explain the invention.

FIG. 1 shows an illustration of the relationship between broader “parent” categories and narrower “child” sub-categories. In said illustration, Tier 1 101 contains an informational entry represented as “Sports”. This entry serves as the “parent” of the informational entries represented in Tier 2 102, which are the “child” sub-categories of “Sports”, and are represented as the entries of sports terms “Baseball”, “Hockey”, “Football”, “Lacrosse”, “Basketball”, “Tennis”, and “Archery”. In Tier 2, the informational entry “Basketball”, which is a “child” of the informational entry “Sports”, also serves as the “parent” of the entries in Tier 3 103, which represent various basketball leagues. In Tier 3, the informational entry “NBA Basketball”, which is a “child” of the informational entry “Basketball”, also serves as the “parent” of the entries in Tier 4 104, which represent National Basketball Association (NBA) teams. In Tier 4, the informational entry “Chicago Bulls”, which is a “child” of the informational entry “NBA Basketball”, also serves as the “parent” of the entries in Tier 5 105, which represent various players on the roster of the Chicago Bulls. When the system and/or method calculate point values for matches, the number of points awarded to a match for a matched informational entry in a “child” category will be higher than the number of points awarded to a match for a matched informational entry in the child's “parent” category. For this reason, in the illustrated example of FIG. 1, matches in Tier 5 105 will be awarded more points than matches in Tier 4 104; matches in Tier 4 104 will be awarded more points than matches in Tier 3 103; matches in Tier 3 103 will be awarded more points than matches in Tier 2 102; and matches in Tier 2 102 will be awarded more points than matches in Tier 1 101.

FIG. 2 shows a representative embodiment of a positive feedback loop used by the system and method. In said embodiment, specific selected data is collected 210 for pre-processing from sources comprising the “visibility” and “active/inactive” attributes of users 220 obtained from a data repository, the positions of users 230 as determined by a position-tracking function of the system and/or method, and the “position” attributes of items 240 obtained from a data repository. Said specific selected data 210 is then inputted into the system and/or method's overall data processing procedure 250, which in this embodiment comprises pre-processing and additional data collection and processing steps 251. These additional data collection and processing steps 251 comprise the collection of additional informational entries 249 from a data repository or data repositories. The results are then outputted and/or displayed to a specified user 260. The system and/or method then determines 270 whether or not said specified user has added or deleted interests, or has changed his or her profile, or has changed his or her location. If so, the positive feedback loop returns 280 to the collection of specific selected data for pre-processing 210. If not, the positive feedback loop concludes 290.

FIG. 3 shows a representative embodiment of a positive feedback loop used by the system and method. In said embodiment, specific selected data is collected 310 for pre-processing from sources comprising the “visibility” and “active/inactive” attributes of users 320 obtained from a data repository, the positions of users 330 as determined by a position-tracking function of the system and/or method, and the “position” attributes of items 340 obtained from a data repository. Said specific selected data 310 is then inputted into the system and/or method's overall data processing procedure 350, which in this embodiment comprises pre-processing and additional data collection and processing steps 351. These additional data collection and processing steps 351 comprise the collection of additional informational entries 349 from a data repository or data repositories. The results are then outputted and/or displayed to a specified user 360. These results are then translated into a visual format 361 comprising a list of items, along with sub-lists comprising each item's associated attributes and/or characteristics. The system and/or method then determines 370 whether or not said specified user has added or deleted interests, or has changed his or her profile, or has changed his or her location. If so, the positive feedback loop returns 380 to the collection of specific selected data for pre-processing 310. If not, the positive feedback loop concludes 390.

FIG. 4 shows a representative embodiment of a positive feedback loop used by the system and method. In said embodiment, specific selected data is collected 410 for pre-processing from sources comprising the “visibility” and “active/inactive” attributes of users 420 obtained from a data repository, the positions of users 430 as determined by a position-tracking function of the system and/or method, and the “position” attributes of items 440 obtained from a data repository. Said specific selected data 410 is then inputted into the system and/or method's overall data processing procedure 450, which in this embodiment comprises pre-processing and additional data collection and processing steps 451. These additional data collection and processing steps 451 comprise the collection of additional informational entries 449 from a data repository or data repositories. The results are then outputted and/or displayed to a specified user 460. Said specified user is then given an opportunity 462 to change his or her profile, to add interests, and/or to delete interests. The system and/or method then determines 470 whether or not said specified user has added or deleted interests, or has changed his or her profile, or has changed his or her location. If so, the positive feedback loop returns 480 to the collection of specific selected data for pre-processing 410. If not, the positive feedback loop concludes 490.

FIG. 5 shows a representative embodiment of a positive feedback loop used by the system and method. In said embodiment, specific selected data is collected 510 for pre-processing from sources comprising the “visibility” and “active/inactive” attributes of users 520 obtained from a data repository, the positions of users 530 as determined by a position-tracking function of the system and/or method, and the “position” attributes of items 540 obtained from a data repository. Said specific selected data 510 is then inputted into the system and/or method's overall data processing procedure 550, which in this embodiment comprises pre-processing and additional data collection and processing steps 551. These additional data collection and processing steps 551 comprise the collection of additional informational entries 549 from a data repository or data repositories. The results are then outputted and/or displayed to a specified user 560. These results are then translated into a visual format 561 comprising a list of items, along with sub-lists comprising each item's associated attributes and/or characteristics. Said specified user is then given an opportunity 562 to change his or her profile, to add interests, and/or to delete interests. The system and/or method then determines 570 whether or not said specified user has added or deleted interests, or has changed his or her profile, or has changed his or her location. If so, the positive feedback loop returns 580 to the collection of specific selected data for pre-processing 510. If not, the positive feedback loop concludes 590.

FIG. 6 shows a representative embodiment of a positive feedback loop used by the system and method. In said embodiment, specific selected data is collected 610 for pre-processing from sources comprising the “visibility” and “active/inactive” attributes of users 620 obtained from a data repository, the positions of users 630 as determined by a position-tracking function of the system and/or method, and the “position” attributes of items 640 obtained from a data repository. Said specific selected data 610 is then inputted into the system and/or method's overall data processing procedure 650, which in this embodiment comprises pre-processing and additional data collection and processing steps 651 as well as a matching procedure 655. Said additional data collection and processing steps 651 comprise the collection of additional informational entries 649 from a data repository or data repositories. The results of this matching procedure are then outputted and/or displayed to a specified user 660. The system and/or method then determines 670 whether or not said specified user has added or deleted interests, or has changed his or her profile, or has changed his or her location. If so, the positive feedback loop returns 680 to the collection of specific selected data for pre-processing 610. If not, the positive feedback loop concludes 690.

FIG. 7 shows a representative embodiment of a positive feedback loop used by the system and method. In said embodiment, specific selected data is collected 710 for pre-processing from sources comprising the “visibility” and “active/inactive” attributes of users 720 obtained from a data repository, the positions of users 730 as determined by a position-tracking function of the system and/or method, and the “position” attributes of items 740 obtained from a data repository. Said specific selected data 710 is then inputted into the system and/or method's overall data processing procedure 750, which in this embodiment comprises pre-processing and additional data collection and processing steps 751 which create outputted results 752 from which attributes and/or characteristics are culled 753 and submitted to a matching procedure 755. Said additional data collection and processing steps 751 comprise the collection of additional informational entries 749 from a data repository or data repositories. The results of this matching procedure are then outputted and/or displayed to a specified user 760. The system and/or method then determines 770 whether or not said specified user has added or deleted interests, or has changed his or her profile, or has changed his or her location. If so, the positive feedback loop returns 780 to the collection of specific selected data for pre-processing 710. If not, the positive feedback loop concludes 790.

FIG. 8 shows a representative embodiment of a positive feedback loop used by the system and method. In said embodiment, specific selected data is collected 810 for pre-processing from sources comprising the “visibility” and “active/inactive” attributes of users 820 obtained from a data repository, the positions of users 830 as determined by a position-tracking function of the system and/or method, and the “position” attributes of items 840 obtained from a data repository. Said specific selected data 810 is then inputted into the system and/or method's overall data processing procedure 850, which in this embodiment comprises pre-processing and additional data collection and processing steps 851 which create outputted results 852 from which attributes and/or characteristics are culled 853 and submitted to a matching, mapping and reducing procedure 855 which utilizes a pre-existing “map-reduce” process. Said additional data collection and processing steps 851 comprise the collection of additional informational entries 849 from a data repository or data repositories. The results of said “matching, mapping and reducing procedure 855 are then outputted and/or displayed to a specified user 860. The system and/or method then determines 870 whether or not said specified user has added or deleted interests, or has changed his or her profile, or has changed his or her location. If so, the positive feedback loop returns 880 to the collection of specific selected data for pre-processing 810. If not, the positive feedback loop concludes 890.

FIG. 9 shows a representative embodiment of a positive feedback loop used by the system and method. In said embodiment, specific selected data is collected 910 for pre-processing from sources comprising the “visibility” and “active/inactive” attributes of users 920 obtained from a data repository, the positions of users 930 as determined by a position-tracking function of the system and/or method, and the “position” attributes of items 940 obtained from a data repository. Said specific selected data 910 is then inputted into the system and/or method's overall data processing procedure 950, which in this embodiment comprises pre-processing and additional data collection and processing steps 951, the results of which are submitted to a mapping procedure 956 which divides data into clusters which are then submitted to separate matching tasks 957, the output of which is submitted to a reducing procedure 959. Said additional data collection and processing steps 951 comprise the collection of additional informational entries 949 from a data repository or data repositories. The results of this reducing procedure 959 are then outputted and/or displayed to a specified user 960. The system and/or method then determines 970 whether or not said specified user has added or deleted interests, or has changed his or her profile, or has changed his or her location. If so, the positive feedback loop returns 980 to the collection of specific selected data for pre-processing 910. If not, the positive feedback loop concludes 990.

FIG. 10 shows a representative embodiment of a positive feedback loop used by the system and method. In said embodiment, specific selected data is collected 1010 for pre-processing from sources comprising the “visibility” and “active/inactive” attributes of users 1020 obtained from a data repository, the positions of users 1030 as determined by a position-tracking function of the system and/or method, and the “position” attributes of items 1040 obtained from a data repository. Said specific selected data 1010 is then inputted into the system and/or method's overall data processing procedure 1050, which in this embodiment comprises pre-processing and additional data collection and processing steps 1051 which create outputted results 1052 from which attributes and/or characteristics are culled 1053 and submitted to a mapping procedure 1056 which divides data into clusters which are then submitted to separate matching tasks 1057, the output of which is submitted to a reducing procedure 1059. Said additional data collection and processing steps 1051 comprise the collection of additional informational entries 1049 from a data repository or data repositories. The results of said reducing procedure 1059 are then outputted and/or displayed to a specified user 1060. Said results are then translated into a visual format 1061 comprising a list of items, along with sub-lists comprising each item's associated attributes and/or characteristics. Said specified user is then given an opportunity 1062 to change his or her profile, to add interests, and/or to delete interests. The system and/or method then determines 1070 whether or not said specified user has added or deleted interests, or has changed his or her profile, or has changed his or her location. If so, the positive feedback loop returns 1080 to the collection of specific selected data for pre-processing 1010. If not, the positive feedback loop concludes 1090.

FIG. 11 shows a representative embodiment of the system and/or method's capability to aggregate, associate, and display data in a “heat map” format. In said embodiment, data relating to various users is contained in a data repository 1101, from which select information regarding users' positions, users' prior or previous positions, and/or other attributes is collected 1102. This collected information is associated 1103 with a specific item or items, and said information and items are processed and filtered 1104 based upon users' positions and/or users' previous positions. Additional data is then collected 1105 from users' profiles to compile aggregate data 1106 on multiple users. From this aggregate data, numerical and/or percentage data is calculated 1107. Said numerical and/or percentage data is then associated 1108 with a specific item or items. Finally, a visual representation 1109 of said numerical and/or percentage data is displayed.

FIG. 12 shows a representative embodiment of the system and/or method's capability to establish a “buddy” relationship, which affects the degree to which users' information is shared with other users. In such an embodiment, a first user could issue a request 1201 to a second user to establish a connection designated as a “buddy” relationship, or equivalent term. Said second user then decides 1202 whether or not to accept said request 1201. If so, a “buddy” connection is established 1203, and otherwise no “buddy” relationship is established 1204. Alternatively in such an embodiment, a second user could issue a request 1205 to a first user to establish a connection designated as a “buddy” relationship, or equivalent term. Said second user then decides 1206 whether or not to accept said request 1205. If so, a “buddy” connection is established 1207, and otherwise no “buddy” relationship is established 1208. If at some later time a user attempts to access 1209 the profile data of another user, the system and/or method determines 1210 whether a “buddy” relationship exists between the two users. If not, a user's access will be limited 1211 to the public profile of the other user. If so, a user will be able to access 1212 the other users' full profile.

FIG. 13 shows a representative embodiment of the system and/or method's interface on a mobile device. A top layer 1310 comprises buttons allowing the user to select the categories of People, Places or Deals. A second layer comprises visual representations of specific interests 1320 and an invitation for the user to add these interests to build up his or her profile. A bottom layer comprises a row of functional buttons 1330.

FIG. 14 shows a representative embodiment of the system and/or method's interface component representing a People/Matches Overview on a mobile device. Tabs 1410 allow a user to switch between the ability to view People, Places and/or Deals. A layer 1420 under the tabs 1410 comprises avatars or other visual representation of the system and or method's users. Under said layer 1420 is a list 1430 of interests and/or preferences belonging to a particular user. Finally, a bottom layer comprises a row of functional button icons 1440. In this particular representative embodiment, a checkmark 1451 highlights and/or represents an interest that the user on the screen shares with the user who is currently logged in to the system and/or method. Also in this particular representative embodiment, a plus sign surrounded by a circle 1452 highlights and/or represents an unshared interest; the plus sign also allows said unshared interest to be added to the profile of the user currently logged in with a tap on said plus sign.

FIG. 15 shows a representative embodiment of the system and/or method's interface component representing Match Details on a mobile device. An upper layer 1510 comprises a username, and a tap button used to return to the previous screen. A second 1520 layer comprises an avatar or other visual representation of the user associated with said username, as well as number of Buddies, number of Followers, and/or other information associated with said username. A third layer 1530 comprises a series of functional button icons. A fourth layer 1540 comprises tabs which allow a user to switch between the ability to view Top Interests, All Interests, or By Category. A fifth layer 1550 comprises a list of interests and/or preferences belonging to the user associated with said username. Finally, a sixth layer 1560 comprises a row of functional button icons. In this particular representative embodiment, a checkmark 1551 highlights and/or represents an interest that the user on the screen shares with the user who is currently logged in to the system and/or method. Also in this particular representative embodiment, a plus sign surrounded by a circle 1552 highlights and/or represents an unshared interest; the plus sign also allows said unshared interest to be added to the profile of the user currently logged in with a tap on said plus sign.

FIG. 16 shows a representative embodiment of the system and/or method's interface component representing “Match Details, Expanded” on a mobile device. An upper layer 1610 comprises a username, and a functional button icon used to return to the previous screen. A second layer 1620 comprises a series of functional button icons. A third layer 1630 comprises an avatar or other visual representation of the user associated with said username, as well as number of Buddies, number of Followers, and/or other information associated with said username. A fourth layer 1640 comprises supplementary information, as well as a functional button icon allowing a user to flag such information as inappropriate. Finally, a fifth layer 1650 comprises a series of functional button icons. In this particular representative embodiment, a checkmark 1651 highlights and/or represents an interest that the user on the screen shares with the user who is currently logged in to the system and/or method. Also in this particular representative embodiment, a plus sign surrounded by a circle 1652 highlights and/or represents an unshared interest; the plus sign also allows said unshared interest to be added to the profile of the user currently logged in with a tap on said plus sign.

FIG. 17 shows a representative embodiment of the system and/or method's interface component representing a buddy request function on a mobile device. A user operating a first device 1710 can send a buddy request 1720 to a user operating a second device 1730, who then is presented with functional button icons 1740 representing various options of how to respond to said buddy request 1720.

FIG. 18 shows a representative embodiment of the system and/or method's interface component representing a invisibility function on a mobile device. A user operating a first device 1810 can operated a functional toggle buton icon 1820 which results 1830 in said user's profile becoming invisible to other users who are operating mobile devices 1840.

FIG. 19 shows a representative embodiment of the system and/or method's interface component representing a Related Interests function on a mobile device. A user can tap or otherwise activate an interest in a list of interests and/or preferences 1910, resulting 1920 in a list of Related Interests 1930 appearing, hence allowing said user to explore and discover new interests that he or she might appreciate.

FIG. 20 shows a representative embodiment of the system and/or method's interface component representing an interest-based related supplemental information function on a mobile device. A user can tap or otherwise activate a visual representation of an interest in a list of interests and/or preferences 2010, allowing for the display and/or entry 2020 of such supplementary information 2030 as photos and/or notes that are associated with said interest.

FIG. 21 shows a representative embodiment of the system and/or method's interface component representing a place and/or interest-based related supplemental information function on a mobile device. A user viewing a list of places and/or interests 2110 can tap or otherwise activate a visual representation of an interest, resulting in supplemental information related to such interest being displayed 2130, potentially allowing certain specific users (e.g., merchants) to communicate detailed information regarding their place's features to other users. Such an embodiment might also comprise a menu 2140 which allows a user to designate an item, place, interest, or other informational entry as “most visited” or “most recommended”.

FIG. 22 shows a representative embodiment of the system and/or method's interface components representing Place Recommendations and/or Place Match Details on a mobile device. A first layer comprises a place name 2210. A second layer 2220 comprises informational details regarding the place associated with said place name 2210. A third layer 2230 comprises avatars or other visual representation of products. Another layer 2240 comprises recommendations pertaining to the place associated with said place name. Additionally, a user can tap or otherwise activate a visual representation indicating Matches, thereby displaying a list 2250 of attributes, characteristics, interests or other informational entries associated with a matching informational entry.

FIG. 23 shows a representative embodiment of the system and/or method's interface components representing Place More Info and Place Offers functions on a mobile device. A first layer comprises a place name 2310. A second layer 2320 comprises a map which indicates the position of, and/or other informational details regarding, the place associated with said place name 2310. Such informational details might comprise hours of business operation at various times of the day and/or week 2330. Additionally, a user can tap or otherwise activate a visual representation indicating Offers, thereby displaying a list 2340 of offers, deals, sale specials, and/or discounts associated with a place, a service, and/or a product.

FIG. 24 shows a representative embodiment of the system and/or method's interface components representing a Mood Mode function on a mobile device. With said function, a user can designate 2410 a category, item, interest, or other informational entry as something that the user is currently in the mood for. This switches said Mood Mode on for said informational entry. Activation status of Mood Mode is indicated by a visual representation 2420.

FIG. 25 shows a representative embodiment of the system and/or method's interface components representing Deals/Matches Overview and Deal Details functions on a mobile device. In such an embodiment, a user can transition 2510 from a main deals screen 2520 to a Deal Details screen which comprises a functional button icon indicating “Map” 2530 that a user can tap or otherwise activate to display a map relating to a particular displayed deal, and which also comprises informational details 2540 relating to said particular displayed deal.

FIG. 26 shows a representative embodiment of the system and/or method's interface components representing a messaging function on a mobile device. A first field 2610 allows a recipient or recipients to be designated. A second field 2620 might be used to display received and/or previously sent messages. A third field 2630 can be used to input textual and/or other information designated for sending to other parties. Such information could be entered with the aid of a keyboard-style interface 2640.

I claim:

1. A method of processing information from a data-storage repository, comprising:
collecting information from a previously existing database or other data-storage repository;
operating a multi-dimensional positive feedback loop wherein a specialized, context-sensitive matching procedure which comprises a map-reduce procedure is used to match portions of said collected information with other portions of said collected information;
calculating the degree to which said matched information is matched to other information within the feedback loop's matching procedure; and
returning and distributing calculated, context-sensitive results which are determined by the aforesaid degree to which said matched information is matched to other information within the feedback loop's matching procedure.

2. A method as in claim 1, wherein the collected information comprises items, informational terms and/or informational entries, each of which in turn comprises common interests or tastes, personal characteristics, features or characteristics of places or locations, attributes of deals, discounts, or sale specials, attributes or characteristics of one or more users; attributes of a user combined with attributes of a place, location, business enterprise, or other establishment; or attributes of a user combined with such informational constructs as deals, discounts or sale specials and/or supplemental user-entered information that becomes associated with existing items, informational terms and/or informational entries.

3. A method as in claim 2, wherein the specialized, context-sensitive matching procedure includes a number of linear and/or non-linear matching procedures, wherein said linear matching procedures calculate a value and/or number as measured in points, or another weighting intermediary, by beginning at a predetermined number of points and decreasing the points awarded in a linear manner based upon a predetermined gap in points, or other dissimilarities, between the two inputted attributes, with a zero-point minimum and also wherein a result or results obtained from the specialized, context-sensitive matching procedure are returned in an order determined by a function both of geographical distance of said result or results from a user, and of the number of points resulting from a match.

4. A method as in claim 3, wherein the collected information, prior to being processed by said positive feedback loop, are first parsed by a number of pre-processing steps, and are eliminated if information designating the item's status indicates that the item is not within a predetermined radius of a designated user; or, if information associated with an item indicates that a visibility preference is set to hide the entity's visibility to other users; or, information associated with an item indicates that the item has active status, and/or lacks the status of being inactive, deleted, and/or disabled.

5. A method as in claim 4, wherein portions of the collected information in said database or other data-storage repository are associated with multiple hierarchical layers or tiers of broader upper categories and narrower sub-categories, and wherein said broader and narrower categories in an associated can be associated with attributes, items, or characteristics following a hierarchical model by creating a “parent/child relationship” between attributes, items, or characteristics with the upper and narrower categories, and wherein the matching procedure implemented by or within the positive feedback loop assigns more weight to matched informational items within the same narrower “child” category than it assigns to matched informational items within the same broader “parent” category, and also wherein collected information can be designated to be given an increased value and/or an increased number of points when matched by said specialized, context-sensitive matching procedure.

6. A method as in claim 5, wherein collected information which are deemed to be equivalent to each other are capable of being associated with information which identifies them as being equivalent to each other, and are capable of being processed identically by said specialized, context-sensitive matching procedure, and also wherein collected information deemed to be related to each other are capable of being associated with information which identifies them as being related to each other, and are capable of being processed in analogous ways by said specialized, context-sensitive matching procedure.

7. A method as in claim 6, wherein collected information are capable of being added to a profile, and wherein an opportunity is provided to associate additional information with said collected information.

8. A method as in claim 7, wherein items, informational terms and/or informational entries are capable of being associated with aggregate data collected from multiple users or multiple items, and wherein said aggregate data is compiled into percentages or numbers of users with similar characteristics, and wherein said aggregate data is associated with positions of users, prior positions of users, previous position of users, and/or specific time periods, and also wherein said aggregate data, after being compiled, is represented and/or returned to a user or users through a visual representation or another user-decipherable form.

9. A method as in claim 8, wherein information capable of specifically identifying a user or users is not disclosed to other users, and wherein previously undisclosed user information is shared with other users in response to user instructions, queries, establishment of a specialized connection relationship, or other affirmative steps.

10. A method as in claim 9, comprising the additional step of sending a communication to a receiving point when or after said specialized, context-sensitive matching procedure determines a match whose weighted value surpasses a predetermined threshold, whose distance from a user is within a certain radius, and/or whose designation matches specific predetermined status.

11. A system for processing information from a data-storage repository, comprising:
a database or other data storage which contains information, and which contains associations and/or connections between said information and related information; and
a multi-dimensional positive feedback loop wherein information collected is matched with other information collected according to a specialized, context-sensitive matching procedure which comprises a map-reduce procedure.

12. A system as in claim 11, wherein said information comprises collected information, each of which in turn comprises common interests or tastes, personal characteristics, features or characteristics of places or locations, attributes of deals, discounts, or sale specials, attributes or characteristics of one or more users; attributes of a user combined with attributes of a place, location, business enterprise, or other establishment; or attributes of a user combined with such informational constructs as deals, discounts or sale specials and/or supplemental user-entered information that becomes associated with existing informational entries.

13. A system as in claim 12, wherein the specialized, context-sensitive matching procedure includes a number of linear and/or non-linear matching procedures, wherein said linear matching procedures calculate a value and/or number as measured in points, or another weighting intermediary, by beginning at a predetermined number of points and decreasing the points awarded in a linear manner based upon a predetermined gap in points, or other dissimilarities, between the two inputted attributes, with a zero-point minimum.

14. A system as in claim 13, wherein a result or results obtained from the specialized, context-sensitive matching procedure are returned in an order determined by a function both of geographical distance of said result or results from a user, and of the number of points resulting from a match.

15. A system as in claim 14, wherein items, informational terms and/or or other informational entries, prior to being processed by said positive feedback loop, are first parsed by a number of pre-processing steps, and are eliminated if information designating the item's status indicates that the item is not within a predetermined radius of a designated user; or, if information associated with an item indicates that a visibility preference is set to hide the entity's visibility to other users; or, information associated with an item indicates that the item has active status, and/or lacks the status of being inactive, deleted, and/or disabled.

16. A system as in claim 15, wherein portions of the information in said database or other data storage repository are associated with multiple hierarchical layers or tiers of broader upper categories and narrower sub-categories, and wherein said broader and narrower categories in an associated can be associated with attributes, items, or characteristics following a hierarchical model by creating a “parent/child relationship” between attributes, items, or characteristics with the upper and narrower categories, and wherein the matching procedure implemented by or within the positive feedback loop assigns more weight to matched informational items within the same narrower “child” category than it assigns to matched informational items within the same broader “parent” category, and also wherein collected information can be designated to be given an increased value and/or an increased number of points when matched by said specialized, context-sensitive matching procedure.

17. A system as in claim 16, wherein collected information are capable of being added to a profile, and wherein an opportunity is provided to associate additional information with said collected information.

18. A system as in claim 17, wherein collected information are capable of being associated with aggregate data collected from multiple users or multiple items, and wherein said aggregate data is compiled into percentages or numbers of users with similar characteristics, and wherein said aggregate data is associated with positions of users, prior positions of users, previous position of users, and/or specific time periods, and also wherein said aggregate data, after being compiled, is capable of being represented and/or returned to a user or users through a visual representation or another user-decipherable form.

19. A system as in claim 18, wherein information capable of specifically identifying a user or users is not disclosed to other users, and wherein previously undisclosed user information is shared with other users in response to user instructions, queries, establishment of a specialized connection relationship, or other affirmative steps.

20. A system as in claim 19, further comprising a communication system wherein a communication is capable of being sent to a receiving point when or after said specialized, context-sensitive matching procedure determines a match whose weighted value surpasses a predetermined threshold, whose distance from a user is within a certain radius, and/or whose designation matches specific predetermined status.
